(19) United States
(12) Patent Application Publication
(10) Pub. No.: US 2026/0158793 A1
(43) Pub. Date: Jun. 11, 2026

(54) LIQUID CONTAINER

(71) Applicant: CANON KABUSHIKI KAISHA, Tokyo (JP)

(72) Inventors: KATSUMI EDA, Tokyo (JP); HIROSHI INOMATA, Kanagawa (JP); YUKI KOZUKA, Tokyo (JP); SATOSHI KUDO, Tokyo (JP); KAZUYUKI YOSHIDA, Kanagawa (JP)

(21) Appl. No.: 19/180,675

(22) Filed: Apr. 16, 2025

(30) Foreign Application Priority Data
Apr. 22, 2024 (JP) 2024-068803

(51) Int. Cl. B41J 2/175; B65D 75/30; B65D 75/58

(52) U.S. Cl. CPC B41J 2/17513; B41J 2/17523; B65D 75/30; B65D 75/5883; B41J 2002/17516

(57) ABSTRACT

A liquid container for supplying a liquid to a liquid ejection apparatus that ejects liquid includes a liquid-containing bag that contains a liquid, a connection port connected to the liquid-containing bag and connects the liquid-containing bag to the liquid ejection apparatus, and a biasing member that applies a biasing force to wind the liquid-containing bag, where the biasing member is connected to the liquid-containing bag. The liquid-containing bag is wound due to the biasing force of the biasing member as the amount of liquid contained in the liquid-containing bag decreases so that a length of the liquid-containing bag in an extending direction of the connection port or a length of the liquid-containing bag in a direction intersecting the extending direction and a vertical direction becomes shorter.

### BACKGROUND

### Field

The present disclosure relates to a liquid container.

### Description of the Related Art

Conventionally, a supply method using a liquid container is known as a method for supplying liquid to a liquid ejection apparatus. Japanese Patent No. 6372322 discloses a technology relating to a cartridge including a liquid container that contains a liquid such as an ink, and a case for accommodating the liquid container. The liquid container includes a liquid-containing bag formed from two sheets made of resin. If the liquid contained in the liquid-containing bag is supplied to a liquid ejection apparatus, the two sheets forming the liquid-containing bag flex in directions that bring them into contact with each other. A used liquid container is removed from the case within the cartridge, and an unused liquid container is attached to the case in place of the used liquid container.

Used liquid containers removed from the case within the cartridge are folded or rolled up by an operator. Thus, the way in which used liquid containers are handled varies depending on the operator. In order to reuse or recycle liquid containers, space-saving for the used liquid containers is desirable. However, if used liquid containers are rolled up in a messy way, a larger space is required to collect the used liquid containers.

### SUMMARY

A liquid container that supplies a liquid to a liquid ejection apparatus that ejects liquid according to an embodiment of the present disclosure includes a liquid-containing bag configured to contain a liquid, a connection port connected to the liquid-containing bag and configured to connect the liquid-containing bag to the liquid ejection apparatus, and a biasing member configured to apply a biasing force to wind the liquid-containing bag. The biasing member is formed from a wire and connected to the liquid-containing bag. The liquid-containing bag is wound based on the biasing force of the biasing member as the amount of liquid contained in the liquid-containing bag decreases so that a length of the liquid-containing bag in an extending direction of the connection port or a length of the liquid-containing bag in a direction intersecting the extending direction and a vertical direction becomes shorter.

Further features of the present disclosure will become apparent from the following description of exemplary embodiments with reference to the attached drawings.

### BRIEF DESCRIPTION OF THE DRAWINGS

FIG. 1 is a schematic view of a liquid ejection apparatus.

FIG. 2A and FIG. 2B are schematic diagrams of a liquid container according to a first embodiment.

FIG. 3 is a bottom view of the liquid container according to the first embodiment.

FIG. 4A to FIG. 4C are side views illustrating the states of a liquid-containing bag in the liquid container according to the first embodiment.

FIG. 5 is a bottom view illustrating a modification example of the liquid container according to the first embodiment.

FIG. 6A and FIG. 6B are schematic diagrams of a liquid container according to a second embodiment.

FIG. 7A to FIG. 7C are side views illustrating the states of a liquid-containing bag in the liquid container according to the second embodiment.

FIG. 8A and FIG. 8B are schematic diagrams of a liquid container according to a third embodiment.

FIG. 9A to FIG. 9C are side views illustrating the states of a liquid-containing bag in the liquid container according to the third embodiment.

FIG. 10A and FIG. 10B are schematic diagrams of a liquid container according to a fourth embodiment.

FIG. 11A to FIG. 11C are side views illustrating the states of a liquid-containing bag in the liquid container according to the fourth embodiment.

FIG. 12 is a side view illustrating a first modification example of the liquid container according to the fourth embodiment.

FIG. 13 is a perspective view illustrating a second modification example of the liquid container according to the fourth embodiment.

FIG. 14 is a front view illustrating a third modification example of the liquid container according to the fourth embodiment.

### DESCRIPTION OF THE EMBODIMENTS

Hereinafter, a detailed description is provided of exemplary embodiments of the present disclosure with reference to the accompanying drawings. The following embodiments are not intended to limit the contents of the present disclosure, and every combination of the characteristics described in the following embodiments is not necessarily essential to the solutions provided in the present disclosure. The dimensions, materials, shapes, relative positions, etc., of the components described in the following embodiments may be appropriately changed depending on the configuration of the liquid container to which the present disclosure is applied, various conditions, and the like. The same configurations are assigned with the same signs for their explanations.

The technologies described in this specification have the potential to contribute to the achievement of a sustainable society, such as a decarbonized society/circular society.

### First Embodiment

In a first exemplary embodiment a description is provided regarding liquid containers that implement space-saving for used liquid containers.

### <Configuration of the Liquid Ejection Apparatus>

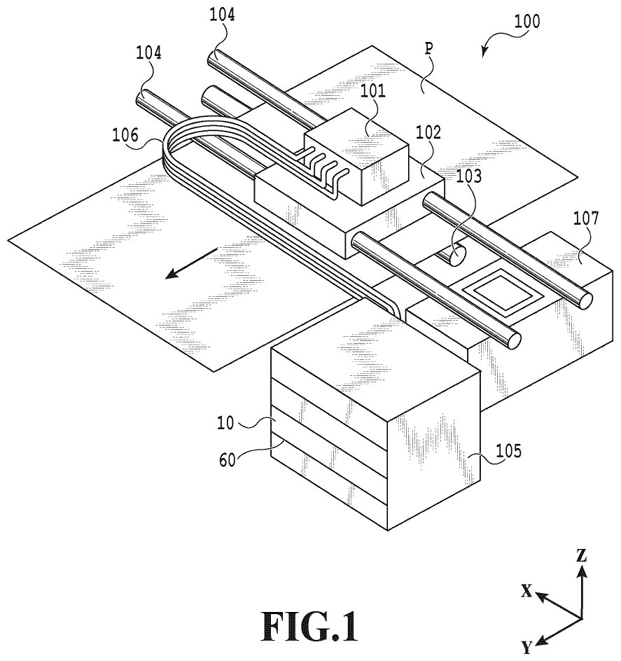

FIG. 1 is a schematic view of a liquid ejection apparatus 100 according to the present embodiment. As illustrated in FIG. 1, the liquid ejection apparatus 100 includes a liquid ejection head 101, a carriage 102, a conveyance roller 103, a liquid supply unit 105, a liquid supply tube 106, and a recovery unit 107. The liquid ejection apparatus 100 repeats reciprocal movement of the liquid ejection head 101 (main scanning) and conveyance of a printing sheet P, which is a print medium, on a per predetermined pitch basis (sub scanning). The liquid ejection apparatus 100 causes the liquid ejection head 101 to selectively eject multiple colors of liquids (e.g., inks, etc.) in synchronization with the main scanning and sub scanning described above so that the liquids land on the printing sheet P, thereby forming characters, symbols, images, etc. Examples of the liquid ejection apparatus 100 include an inkjet printer, etc.

The print medium is not limited to the printing sheet P, but may be anything on which an image, etc., can be formed by depositing ink droplets on it. For example, print media of various materials and forms such as paper, cloth, an optical disk label, a plastic sheet, an OHP sheet, and an envelope can be used. In each drawing referred to below, the Z direction indicates the vertical direction, which intersects (perpendicularly in the present embodiment) the X-Y plane defined by the X direction and Y direction.

The liquid ejection head 101 is removably mounted on the carriage 102. The carriage 102 is supported by two guide rails 104 in a free-to-slide manner in the X direction. With a driving unit (not illustrated) such as a motor, the carriage 102 on which the liquid ejection head 101 is mounted moves reciprocally in a straight line along the guide rails 104.

The printing sheet P is conveyed by the conveyance roller 103, which is a conveyance unit, in a direction intersecting the moving direction of the carriage 102. More specifically, in a direction (Y direction) perpendicular to the moving direction of the carriage 102. The printing sheet P being conveyed by the conveyance roller 103 faces a liquid ejection part (not illustrated) of the liquid ejection head 101. The liquid ejected from the liquid ejection part of the liquid ejection head 101 lands on the printing sheet P facing the liquid ejection part of the liquid ejection head 101.

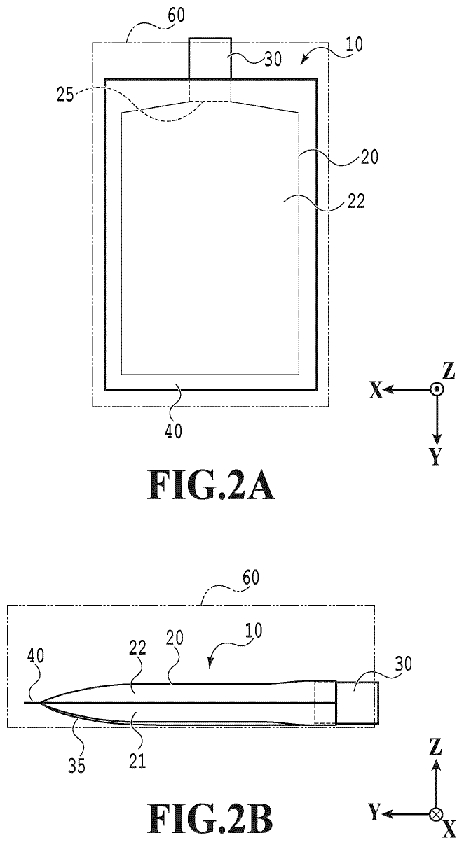

The liquid ejection head 101 has multiple nozzle arrays for ejecting different colors of inks, respectively, as a plurality of liquid ejection parts. A plurality of independent liquid containers 10 is attached to the liquid supply unit 105 in accordance with the multiple colors of liquids ejected from the liquid ejection head 101. Each liquid container 10, in a state accommodated inside the case 60 (See FIG. 2A and FIG. 2B), for example, is removably attached to the liquid supply unit 105. The case 60 is formed in a box shape with one end (−Y direction side) open.

The liquid supply unit 105 and the liquid ejection head 101 are connected via a plurality of the liquid supply tubes 106 corresponding to the multiple colors of liquids. By attaching the liquid containers 10 to the liquid supply unit 105, the liquids of the respective colors contained in the liquid containers 10 can be independently supplied to the respective nozzle arrays of the liquid ejection head 101. This enables the liquid ejection apparatus 100 to include a function of ejecting liquids supplied from the liquid containers 10.

The recovery unit 107 is installed in a non-printing area within the range of the reciprocal movement of the liquid ejection head 101 and outside the range through which the printing sheet P passes. The recovery unit 107 is placed at a position that faces the liquid ejection part (not illustrated) of the liquid ejection head 101 moved to the above-described non-printing area. The recovery unit 107 includes a cap part, a suction mechanism, a cleaning blade, etc.

The cap part of the recovery unit 107 is a member for capping the liquid ejection part of the liquid ejection head 101. The suction mechanism of the recovery unit 107 is a mechanism for forcibly suctioning liquid in a state where the liquid ejection part of the liquid ejection head 101 is capped. The cleaning blade of the recovery unit 107 is a member for wiping soiling off the liquid ejection part of the liquid ejection head 101. The recovery process by the recovery unit 107, which includes capping with the cap part and suctioning of liquid by the suction mechanism, is performed prior to a liquid ejection operation of the liquid ejection apparatus 100. Even in a case where the liquid ejection apparatus 100 is operated after having been left unused for a long period of time, the recovery process performed by the recovery unit 107 can remove air bubbles remaining in the liquid ejection part of the liquid ejection head 101, liquid that has thickened in the vicinity of ejection ports of the liquid ejection head 101, etc. Accordingly, the ejection characteristics of the liquid ejection head 101 are maintained.

### <Configuration of the Liquid Container>

Next, a description is provided regarding the liquid container 10 according to the first embodiment. As described above, a plurality of the independent liquid containers 10 is attached to the liquid supply unit 105 in accordance with the multiple colors of liquids ejected from the liquid ejection head 101. Each liquid container 10, in a state accommodated inside the case 60, for example, is removably attached to the liquid supply unit 105. Each of the liquid containers 10 has basically the same configuration.

FIG. 2A and FIG. 2B are schematic diagrams of the liquid container 10 according to the first embodiment. In FIG. 2A and FIG. 2B to FIG. 14, the X direction, Y direction, and Z direction indicate the directions of the liquid container 10 in a state attached to the liquid supply unit 105. FIG. 2A is a plan view of the liquid container 10 according to the first embodiment. FIG. 2B is a side view of the liquid container 10 according to the first embodiment. As illustrated in FIG. 2A and FIG. 2B, the liquid container 10 according to the first embodiment includes a liquid-containing bag 20 and a connection port 30 for connecting the liquid-containing bag 20 to the liquid ejection apparatus 100.

The liquid-containing bag 20 contains ink, which is an example of a liquid to be supplied to the liquid ejection apparatus 100. The liquid-containing bag 20 includes a first sheet member 21 and a second sheet member 22, which is located vertically above and overlaps the first sheet member 21. The first sheet member 21 and the second sheet member 22 are each formed of the same resin material and into a rectangular sheet shape. The outer peripheries 40 of the first sheet member 21 and the second sheet member 22 are bonded by thermal welding. Of the rectangles of the first sheet member 21 and the second sheet member 22, a portion of each outer periphery 40 forming one of the short sides (the −Y direction side) is bonded to the connection port 30 by thermal welding. Accordingly, ink is contained in a clearance part 25 between the first sheet member 21 and the second sheet member 22 surrounded by the outer peripheries 40.

In order to suppress evaporation of water contained in the ink and permeation of a solvent (to ensure the gas barrier property), the liquid-containing bag 20 (the first sheet member 21 and the second sheet member 22) is configured with multiple layers. For example, the liquid-containing bag 20 (the first sheet member 21 and the second sheet member 22) has an outer layer that faces outward and contacts the outside air and an inner layer that faces inward and contacts the ink. The outer layer of the liquid-containing bag 20 is formed of polyethylene terephthalate (PET). The inner layer of the liquid-containing bag 20 is formed of polypropylene (PP). Between the outer layer and the inner layer of the liquid-containing bag 20, an aluminum layer is deposited to ensure the gas barrier property.

The connection port 30 is bonded to an end of the longitudinal direction (the end in the −Y direction) of the liquid-containing bag 20 (the first sheet member 21 and the second sheet member 22). The connection port 30 is formed in a cylindrical shape extending in the longitudinal direction of the liquid-containing bag 20 (the Y direction intersecting the Z direction, which is the vertical direction), and is connected to the liquid ejection apparatus 100. In the state where the connection port 30 is connected to the liquid ejection apparatus 100, the inside of the liquid-containing bag 20 and the inside of the liquid supply tube 106 are in communication with each other. The connection port 30 has a check valve (not illustrated) and a sealing rubber (not illustrated). The check valve of the connection port 30 prevents air from entering internal to the liquid-containing bag 20 (backflow) and ink from dripping from the connection port 30 at the time the liquid container 10 is being removed from the liquid supply unit 105. The sealing rubber of the connection port 30 ensures the sealing property of the connection port 30 connected to the liquid ejection apparatus 100.

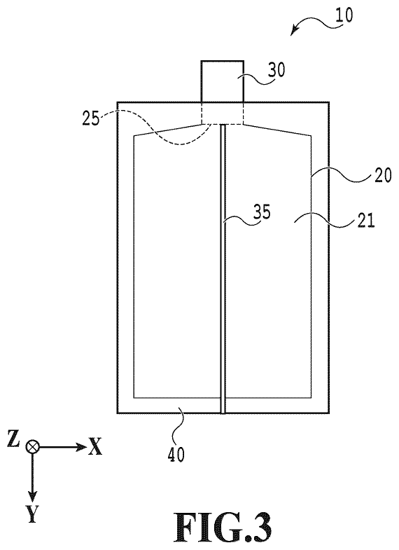

FIG. 3 is a bottom view of the liquid container 10 according to the first embodiment. As illustrated in FIG. 3, the liquid container 10 according to the first embodiment includes a biasing member 35. The biasing member 35 is formed from a metal wire that has a curling habit like a so-called “party blower.” The biasing member 35 is attached to the central area of the bottom surface of the liquid-containing bag 20 (the first sheet member 21) to extend from the side where the connection port 30 is placed to the opposite side of the connection port 30. This enables the biasing member 35 to apply a biasing force for winding the liquid-containing bag 20 into a roll (scroll) due to the curling habit of the biasing member 35. An example of the wire used for the biasing member 35 is a stainless-steel wire with a wire diameter of 0.3 mm. The wire diameter and material of the wire used for the biasing member 35 are not limited to this type of wire or diameter.

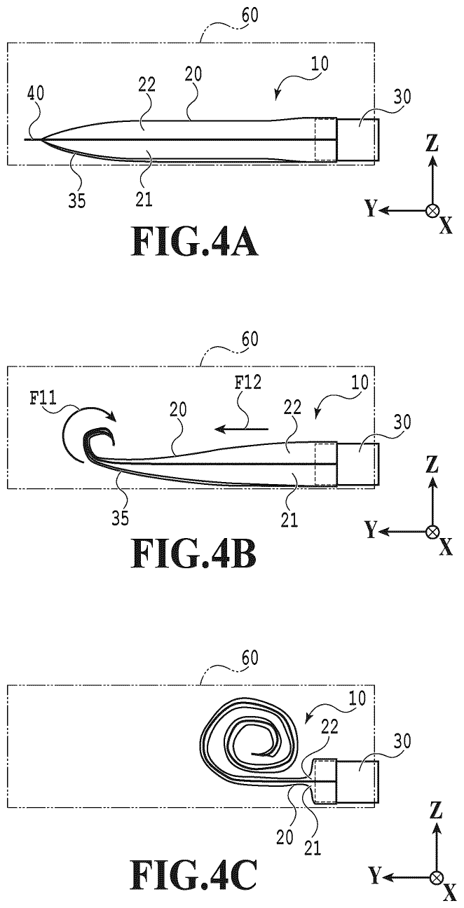

Next, a description is provided regarding the states of the liquid-containing bag 20 based on the remaining amounts of ink. FIG. 4A to FIG. 4C are side views illustrating the states of the liquid-containing bag 20 in the liquid container 10 according to the first embodiment. FIG. 4A is a side view illustrating the state where ink has been filled the liquid-containing bag 20. FIG. 4B is a side view illustrating the state where the ink inside the liquid-containing bag 20 is decreasing. FIG. 4C is a side view illustrating the state where there is only a small amount of ink inside the liquid-containing bag 20.

As illustrated in FIG. 4A, if ink is fills the liquid-containing bag 20, a force that stretches the liquid-containing bag 20 into a flat plate shape is generated based on the weight and volume of the ink. The liquid-containing bag 20 becomes stretched into a flat plate shape against the biasing force of the biasing member 35. As illustrated in FIG. 4B, as the ink is supplied from the liquid container 10 to the liquid ejection apparatus 100 and the amount of ink inside the liquid-containing bag 20 decreases, the liquid-containing bag 20 is gradually wound up into a roll due to the biasing force of the biasing member 35. At this time, the rolled shape of the liquid-containing bag 20 is maintained at a position where the force F11 that winds the liquid-containing bag 20 based on the biasing force of the biasing member 35 is equal to the force F12 that stretches the liquid-containing bag 20 into a flat plate shape based on the weight and volume of the remaining ink. The biasing force of the biasing member 35 is determined based on the material, wire diameter, and curling habit of the wire used for the biasing member 35. The force F12 that stretches the liquid-containing bag 20 into a flat plate shape is determined based on the pressure caused by the ink inside the liquid-containing bag 20. As illustrated in FIG. 4C, if there is only a small amount of ink inside the liquid-containing bag 20, the pressure caused by the ink inside the liquid-containing bag 20 approaches zero, and thus the liquid-containing bag 20 is rolled up to the vicinity of the connection port 30 due to the biasing force of the biasing member 35.

This causes, inside the case 60, the liquid-containing bag 20 to change from a state extending in a flat plate shape to a state wound up into a roll extending in the width direction (the X direction) of the liquid-containing bag 20. Therefore, as the ink contained in the liquid-containing bag 20 decreases, the length of the liquid-containing bag 20 in the extending direction (the Y direction) of the connection port 30 decreases. The used liquid container 10 illustrated in FIG. 4C is removed from the liquid supply unit 105 and removed from the case 60. Then, in place of the used liquid container 10, an unused liquid container 10 is accommodated inside the case 60 and attached to the liquid supply unit 105.

In the present embodiment, as the ink contained in the liquid-containing bag 20 decreases, the liquid-containing bag 20 is wound up, and the length of the liquid-containing bag 20 in the extending direction (the Y direction) of the connection port 30 becomes shorter. This enables preventing the space required for collecting the used liquid containers 10 from becoming large. In addition, it is possible to prevent differences in the space required for collecting the used liquid containers 10 from occurring depending on how the operator handles the liquid containers 10. Thus, implementing space-saving for the used liquid containers 10 can be achieved.

As the ink contained in the liquid-containing bag 20 decreases, the liquid-containing bag 20 is wound up by the biasing force of the biasing member 35. This enables the shape of the liquid-containing bag 20 filled with ink to have a certain shape (flat plate shape), and the liquid-containing bag 20 can be reliably wound up and made smaller by the biasing force of the biasing member 35.

The biasing member 35 is formed from a wire and is attached to the liquid-containing bag 20. This enables simplifying the structure of the biasing member 35.

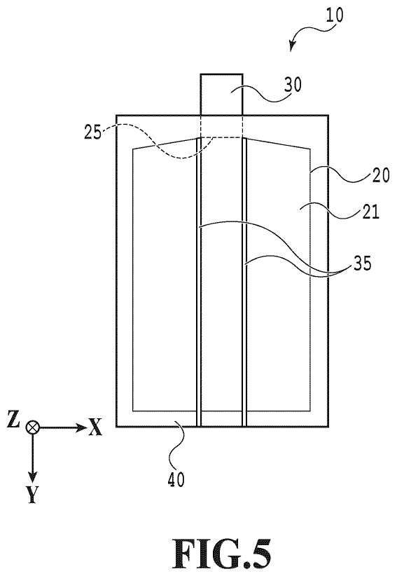

In the above-described embodiment, one biasing member 35 is attached to the bottom surface of the liquid-containing bag 20 (the first sheet member 21), but this is not seen to be limiting. FIG. 5 is a bottom view illustrating a modification example of the liquid container 10 according to the first embodiment. As illustrated in FIG. 5, two biasing members 35 are arranged in parallel along the longitudinal direction of the liquid-containing bag 20 and are attached to the bottom surface of the liquid-containing bag 20 (the first sheet member 21). In another modification three or more biasing members 35 are arranged in parallel and are attached to the bottom surface of the liquid-containing bag 20 (the first sheet member 21), depending on the size of the liquid-containing bag 20 in the width direction (the X direction).

In the above-described first embodiment, the biasing member 35 is formed from a wire that has a circular cross section, but this is not seen to be limiting. For example, the biasing member 35 may be formed from a plate material that has a rectangular cross section. An example of the plate material used for the biasing member 35 is a stainless-steel plate material with a thickness of 0.3 mm and a width of 2.0 mm.

### Second Embodiment

Next, a description of a second embodiment is provided. Since each of the members in the second embodiment has the same configuration as the above-described first embodiment, the description is provided with the same reference numbers as those in the above-described first embodiment. In the present embodiment, a configuration is described in which the liquid-containing bag 20 can be wound up without using a biasing member.

### <Configuration of the Liquid Container>

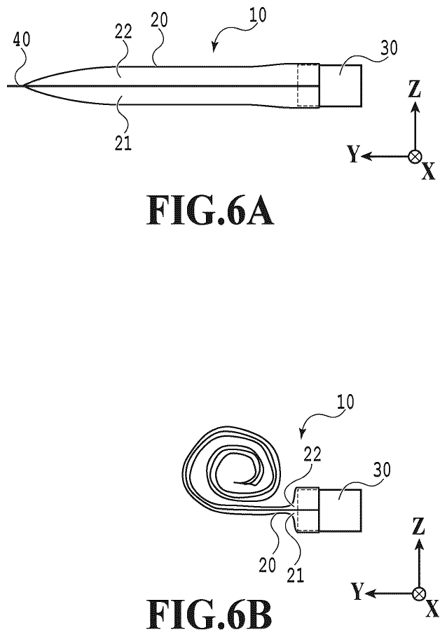

FIG. 6A and FIG. 6B are schematic diagrams of the liquid container 10 according to the second embodiment. FIG. 6A is a side view of the liquid container 10 according to the second embodiment. FIG. 6B is a side view illustrating the liquid container 10 in an unfilled state according to the second embodiment. As illustrated in FIG. 6A and FIG. 6B, the liquid container 10 according to the second embodiment includes the liquid-containing bag 20 and the connection port 30. The connection port 30 according to the second embodiment is configured similarly to the connection port 30 according to the first embodiment.

The liquid-containing bag 20 contains ink to be supplied to the liquid ejection apparatus 100. The liquid-containing bag 20 includes the first sheet member 21 and the second sheet member 22, which is located vertically above and overlaps the first sheet member 21. The first sheet member 21 is formed of a resin material into a rectangular sheet shape. The second sheet member 22 is formed of a resin material different from that of the first sheet member 21 and into a rectangular sheet shape. The outer peripheries 40 of the first sheet member 21 and the second sheet member 22 are bonded by thermal welding. Of the rectangles of the first sheet member 21 and the second sheet member 22, a portion of each outer periphery 40 forming one of the short sides (the −Y direction side) is bonded to the connection port 30 by thermal welding. Accordingly, ink is contained in the clearance part 25 between the first sheet member 21 and the second sheet member 22 surrounded by the outer peripheries 40.

In the second embodiment, a linear expansion coefficient X2 of the material of the second sheet member 22 is greater than a linear expansion coefficient X1 of the material of the first sheet member 21. In other words, there is a relationship of X2>X1. The inner layer of the first sheet member 21 is formed of polypropylene (PP). The outer layer of the first sheet member 21 is formed of polyamide (PA). The inner layer of the second sheet member 22 is formed of polypropylene similar to the inner layer of the first sheet member 21. The outer layer of the second sheet member 22 is formed of a type of polypropylene whose melting point is higher than that of the polypropylene of its inner layer. The linear expansion coefficient X1 of the polyamide that is the material of the first sheet member 21 is, for example, 8×10⁻⁵/° C. The linear expansion coefficient X2 of the polypropylene that is the material of the second sheet member 22 is, for example, 11×10⁻⁵/° C.

The welding temperature of the outer peripheries 40 of the first sheet member 21 and the second sheet member 22 is approximately 140° C. to 160° C. Since the linear expansion coefficient X2 of the material of the second sheet member 22 is greater than the linear expansion coefficient X1 of the material of the first sheet member 21, if they are welded and then cooled to room temperature, the outer periphery 40 of the second sheet member 22 shrinks more than the outer periphery 40 of the first sheet member 21. A force based on the difference between the linear expansion coefficient of the material of the first sheet member 21 and the linear expansion coefficient of the material of the second sheet member 22 acts on the outer peripheries 40 that has been welded and then cooled to room temperature. Therefore, as illustrated in FIG. 6B, the liquid-containing bag 20 in the unfilled state is wound up into a roll due to the force generated based on the difference between the linear expansion coefficient of the material of the first sheet member 21 and the linear expansion coefficient of the material of the second sheet member 22. At this time, the force acts to wind the liquid-containing bag 20 (the first sheet member 21 and the second sheet member 22) along the longitudinal direction (the Y direction) of the liquid-containing bag 20, and thus the liquid-containing bag 20 is wound up with the second sheet member 22 positioned on the inner side of the first sheet member 21.

In the outer peripheries 40, the width of the portions forming the short sides of the rectangles of the first sheet member 21 and the second sheet member 22 (the width in the Y direction) may be wider than the width of the portions forming the long sides of the rectangles of the first sheet member 21 and the second sheet member 22 (the width in the X direction). This enables suppressing the force that winds the liquid-containing bag 20 from acting along the direction (the X direction) perpendicular to the longitudinal direction of the liquid-containing bag 20. The portions of the outer peripheries 40 forming the shorter sides of the rectangles of the first sheet member 21 and the second sheet member 22 may be formed in a corrugated shape whose height changes along the longitudinal direction of the liquid-containing bag 20. This enables suppressing the force that winds the liquid-containing bag 20 from acting along the direction (the X direction) perpendicular to the longitudinal direction of the liquid-containing bag 20.

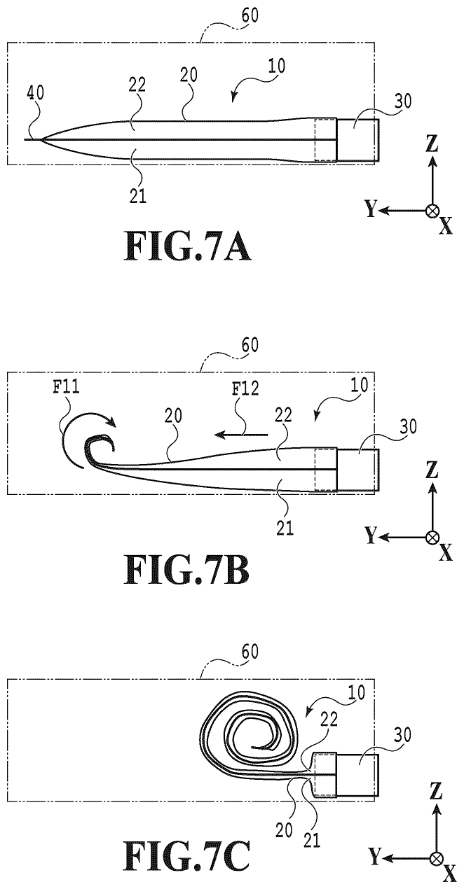

Next, a description is provided regarding the states of the liquid-containing bag 20 based on the remaining amounts of ink. FIG. 7A to FIG. 7C are side views illustrating the states of the liquid-containing bag 20 in the liquid container 10 according to the second embodiment. FIG. 7A is a side view illustrating the state where ink has been filled into the liquid-containing bag 20. FIG. 7B is a side view illustrating the state where the ink inside the liquid-containing bag 20 is decreasing. FIG. 7C is a side view illustrating the state where there is only a small amount of ink inside the liquid-containing bag 20.

As illustrated in FIG. 7A, if ink is fills the liquid-containing bag 20, a force that stretches the liquid-containing bag 20 into a flat plate shape is generated based on the weight and volume of the ink, and the liquid-containing bag 20 becomes stretched into a flat plate shape. As illustrated in FIG. 7B, as the ink is supplied from the liquid container 10 to the liquid ejection apparatus 100 and the amount of ink inside the liquid-containing bag 20 decreases, the liquid-containing bag 20 is gradually wound up into a roll. At this time, the rolled shape of the liquid-containing bag 20 is maintained at a position where the force F11 that winds the liquid-containing bag 20 based on the difference between the linear expansion coefficient of the material of the first sheet member 21 and the linear expansion coefficient of the material of the second sheet member 22 is equal to the force F12 that stretches the liquid-containing bag 20 into a flat plate shape. The force F11 acts to wind the liquid-containing bag 20 (the first sheet member 21 and the second sheet member 22) along the longitudinal direction (the Y direction) of the liquid-containing bag 20, and thus the liquid-containing bag 20 is wound up with the second sheet member 22 positioned on the inner side of the first sheet member 21. As illustrated in FIG. 7C, if there is only a small amount of ink inside the liquid-containing bag 20, the pressure caused by the ink inside the liquid-containing bag 20 approaches zero, and thus the liquid-containing bag 20 is rolled up to the vicinity of the connection port 30.

Based on the above states, inside the case 60, the liquid-containing bag 20 changes from a state extending in a flat plate shape to a state wound up into a roll extending in the width direction (the X direction) of the liquid-containing bag 20. Therefore, as the ink contained in the liquid-containing bag 20 decreases, the length of the liquid-containing bag 20 in the extending direction (the Y direction) of the connection port 30 decreases. The used liquid container 10 illustrated in FIG. 7C is removed from the liquid supply unit 105 and removed the case 60. Then, in place of the used liquid container 10, an unused liquid container 10 is accommodated inside the case 60 and attached to the liquid supply unit 105.

In the present embodiment, as the ink contained in the liquid-containing bag 20 decreases, the liquid-containing bag 20 is wound up, and the length of the liquid-containing bag 20 in the extending direction (the Y direction) of the connection port 30 becomes shorter. This enables preventing the space required for collecting the used liquid containers 10 from becoming large. It is possible to prevent differences in the space required for collecting the used liquid containers 10 from occurring depending on how the operator handles the liquid containers 10. Therefore, it is possible to implement the space-saving for the used liquid containers 10.

As described above, with the liquid container 10 according to the second embodiment, it is possible to implement the space-saving for the used liquid containers 10 similar to the first embodiment.

In the second embodiment, as the ink contained in the liquid-containing bag 20 decreases, the liquid-containing bag 20 is wound up by the force generated based on the difference between the linear expansion coefficient of the material of the first sheet member 21 and the linear expansion coefficient of the material of the second sheet member 22. This enables winding the liquid-containing bag 20 into a smaller shape with a simple configuration without using a biasing member or the like.

In the second embodiment, the outer layer of the first sheet member 21 is formed of polyamide, and the outer layer of the second sheet member 22 is formed of polypropylene, but this is not seen to be limiting. For example, to create a difference between the linear expansion coefficient of the material of the first sheet member 21 and the linear expansion coefficient of the material of the second sheet member 22, a metal layer, other than the layer for ensuring gas barrier property, may be deposited onto the outer layer of the first sheet member 21. In this case, the outer layer of the second sheet member 22 may be formed of polyethylene terephthalate.

### Third Embodiment

Next, a description of a third embodiment is provided. Since each of the members in the third embodiment has the same configuration as in the first embodiment, the description is provided with the same reference numbers as those in the first embodiment. In the present embodiment, a configuration is described in which the liquid-containing bag 20 can be wound up without using a biasing member, the first sheet member 21 and the second sheet member 22 with different linear expansion coefficients, etc.

### <Configuration of the Liquid Container>

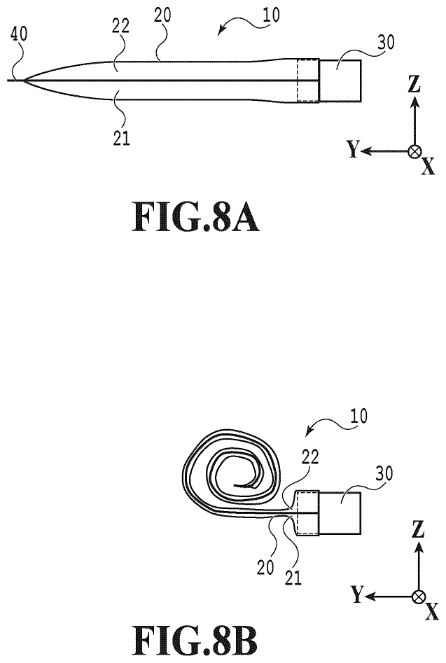

FIG. 8A and FIG. 8B are schematic diagrams of the liquid container 10 according to the third embodiment. FIG. 8A is a side view of the liquid container 10 according to the third embodiment. FIG. 8B is a side view illustrating the liquid container 10 in an unfilled state according to the third embodiment. As illustrated in FIG. 8A and FIG. 8B, the liquid container 10 according to the third embodiment includes the liquid-containing bag 20 and the connection port 30. The connection port 30 according to the third embodiment is configured similarly to the connection port 30 according to the first embodiment.

The liquid-containing bag 20 contains ink to be supplied to the liquid ejection apparatus 100. The liquid-containing bag 20 includes the first sheet member 21 and the second sheet member 22, which is located vertically above and overlaps the first sheet member 21. The first sheet member 21 and the second sheet member 22 are each formed of the same resin material into a rectangular sheet shape as with the first embodiment. The outer peripheries 40 of the first sheet member 21 and the second sheet member 22 are bonded by thermal welding. Of the rectangles of the first sheet member 21 and the second sheet member 22, a portion of each outer periphery 40 forming one of the short sides (the −Y direction side) is bonded to the connection port 30 by thermal welding. Accordingly, ink is contained in the clearance part 25 between the first sheet member 21 and the second sheet member 22 surrounded by the outer peripheries 40.

In the third embodiment, the liquid-containing bag 20 has a curling habit. A curling habit may occur by winding the liquid-containing bag 20 around a cylindrical rod that has been heated to a temperature lower than the melting point of the liquid-containing bag 20. Therefore, as illustrated in FIG. 8B, the liquid-containing bag 20 in the unfilled state is wound up into a roll due to the curling habit that the liquid-containing bag 20 has.

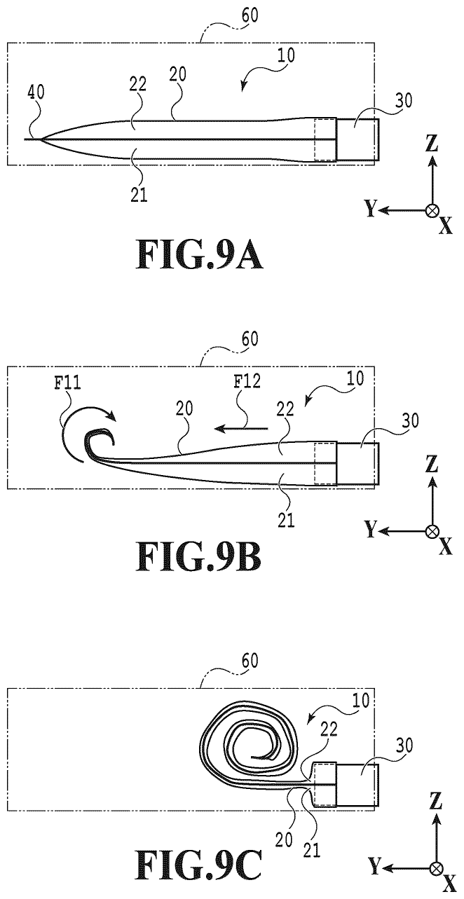

Next, a description is provided regarding the states of the liquid-containing bag 20 based on the remaining amounts of ink. FIG. 9A to FIG. 9C are side views illustrating the states of the liquid-containing bag 20 in the liquid container 10 according to the third embodiment. FIG. 9A is a side view illustrating the state where ink fills the liquid-containing bag 20. FIG. 9B is a side view illustrating the state where the ink inside the liquid-containing bag 20 is decreasing. FIG. 9C is a side view illustrating the state where there is only a small amount of ink inside the liquid-containing bag 20.

As illustrated in FIG. 9A, if ink fills the liquid-containing bag 20, a force that stretches the liquid-containing bag 20 into a flat plate shape is generated based on the weight and volume of the ink, and the liquid-containing bag 20 becomes stretched into a flat plate shape against the curling habit that the liquid-containing bag 20 has. As illustrated in FIG. 9B, as the ink is supplied from the liquid container 10 to the liquid ejection apparatus 100 and the amount of ink inside the liquid-containing bag 20 decreases, the liquid-containing bag 20 is gradually wound up into a roll due to the curling habit of the liquid-containing bag 20. At this time, the rolled shape of the liquid-containing bag 20 is maintained at a position where the force F11 that winds the liquid-containing bag 20 based on the curling habit is equal to the force F12 that stretches the liquid-containing bag 20 into a flat plate shape. As illustrated in FIG. 9C, if there is only a small amount of ink inside the liquid-containing bag 20, the pressure caused by the ink inside the liquid-containing bag 20 approaches zero, and thus the liquid-containing bag 20 is rolled up to the vicinity of the connection port 30 due to the curling habit.

Thus, inside the case 60, the liquid-containing bag 20 changes from a state extending in a flat plate shape to a state wound up into a roll extending in the width direction (the X direction) of the liquid-containing bag 20. Therefore, as the ink contained in the liquid-containing bag 20 decreases, the length of the liquid-containing bag 20 in the extending direction (the Y direction) of the connection port 30 decreases. Note that the used liquid container 10 illustrated in FIG. 9C is to be removed from the liquid supply unit 105 and removed from the case 60. Then, in place of the used liquid container 10, an unused liquid container 10 is accommodated inside the case 60 and attached to the liquid supply unit 105.

In the present embodiment, as the ink contained in the liquid-containing bag 20 decreases, the liquid-containing bag 20 is wound up, and the length of the liquid-containing bag 20 in the extending direction (the Y direction) of the connection port 30 becomes shorter. This enables preventing the space required for collecting the used liquid containers 10 from becoming large. It is possible to prevent differences in the space required for collecting the used liquid containers 10 from occurring depending on how the operator handles the liquid containers 10. Therefore, it is possible to implement the space-saving for the used liquid containers 10.

As described above, with the liquid container 10 according to the third embodiment, it is possible to implement the space-saving for the used liquid containers 10 similar to the first embodiment.

In the third embodiment, as the ink contained in the liquid-containing bag 20 decreases, the liquid-containing bag 20 is wound up due to the curling habit that the liquid-containing bag 20 has. This enables winding the liquid-containing bag 20 into a smaller shape with a simple configuration without using a biasing member or the like.

In the third embodiment, the first sheet member 21 and the second sheet member 22 are formed of the same resin material, but this is not seen to be limiting. For example, to make it easier to give a curling habit to the liquid-containing bag 20, the second sheet member 22 may be formed of a resin material different from that of the first sheet member 21.

In the above-described first to third embodiments, as the ink contained in the liquid-containing bag 20 decreases, the liquid-containing bag 20 is wound up, and the length of the liquid-containing bag 20 in the extending direction (the Y direction) of the connection port 30 becomes shorter. However, this is not seen to be limiting. For example, the liquid-containing bag 20 may be configured to be wound up as the ink contained in the liquid-containing bag 20 decreases, so that the length of the liquid-containing bag 20 in a direction (for example, the X direction) intersecting the extending direction of the connection port 30 and vertical direction becomes shorter. In this way, it is possible to implement the space-saving for the used liquid containers 10.

In the above-described first to third embodiments, a mark indicating the orientation of the liquid container 10 in the up-down direction (the vertical direction), for example a mark indicating that the surface of the second sheet member 22 with it is the upper surface, may be provided on a surface of the second sheet member 22. This makes it possible to prevent the liquid container 10 from being accommodated in the case 60 with the an incorrect orientation in the up-down direction (the vertical direction), and the liquid-containing bag 20 from coming contacting the bottom surface of the case 60 as it is wound up.

### Fourth Embodiment

Next, a description of a fourth embodiment is provided. Since each of the members in the fourth embodiment has the same configuration as in the first embodiment, the description is provided with the same reference numbers as those in the first embodiment. In the present embodiment, a configuration is described in which the liquid-containing bag 20 is given a folding habit instead of a curling habit.

### <Configuration of the Liquid Container>

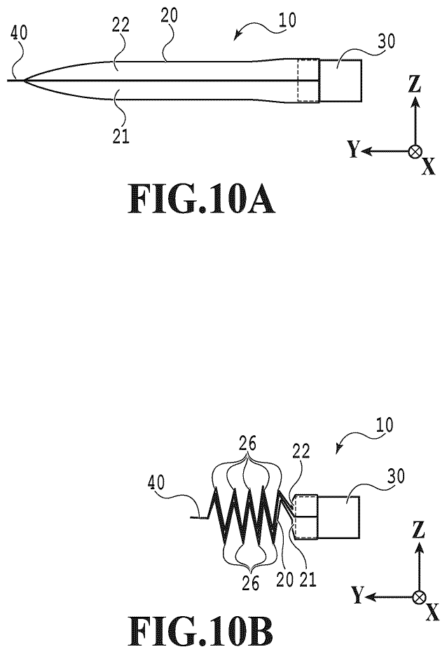

FIG. 10A and FIG. 10B are schematic diagrams of the liquid container 10 according to the fourth embodiment. FIG. 10A is a side view of the liquid container 10 according to the fourth embodiment. FIG. 10B is a side view illustrating the liquid container 10 in an unfilled state according to the fourth embodiment. As illustrated in FIG. 10A and FIG. 10B, the liquid container 10 according to the fourth embodiment includes the liquid-containing bag 20 and the connection port 30. The connection port 30 according to the fourth embodiment is configured similarly to the connection port 30 according to the first embodiment.

The liquid-containing bag 20 contains ink to be supplied to the liquid ejection apparatus 100. The liquid-containing bag 20 includes the first sheet member 21 and the second sheet member 22, which is located vertically above and overlaps the first sheet member 21. The first sheet member 21 and the second sheet member 22 are each formed of the same resin material into a rectangular sheet shape as with the first embodiment. The outer peripheries 40 of the first sheet member 21 and the second sheet member 22 are bonded by thermal welding. Of the rectangles of the first sheet member 21 and the second sheet member 22, a portion of each outer periphery 40 forming one of the short sides (the −Y direction side) is bonded to the connection port 30 by thermal welding. Accordingly, ink is contained in the clearance part 25 between the first sheet member 21 and the second sheet member 22 surrounded by the outer peripheries 40.

In the fourth embodiment, as illustrated in FIG. 10B, the liquid-containing bag 20 has multiple (for example, eleven) creases 26, each of which has a folding habit for folding the liquid-containing bag 20. The multiple creases 26 are arranged along the extending direction (the Y direction) of the connection port 30 and extend in the width direction (the X direction) of the liquid-containing bag 20. For example, it is possible to give a folding habit to each of the multiple creases 26 of the liquid-containing bag 20 by having the liquid-containing bag 20, on which the creases 26 have been given by hand in advance, abut on a mountain-shaped block heated to a temperature lower than the melting point of the liquid-containing bag 20. Therefore, as illustrated in FIG. 10B, the liquid-containing bag 20 in an unfilled state is folded in an accordion shape by the folding habits given to the creases 26. The folding habits can be given to the multiple creases 26 of the liquid-containing bag 20 using a processing device capable of automatically giving the creases 26 and folding habits to the liquid-containing bag 20.

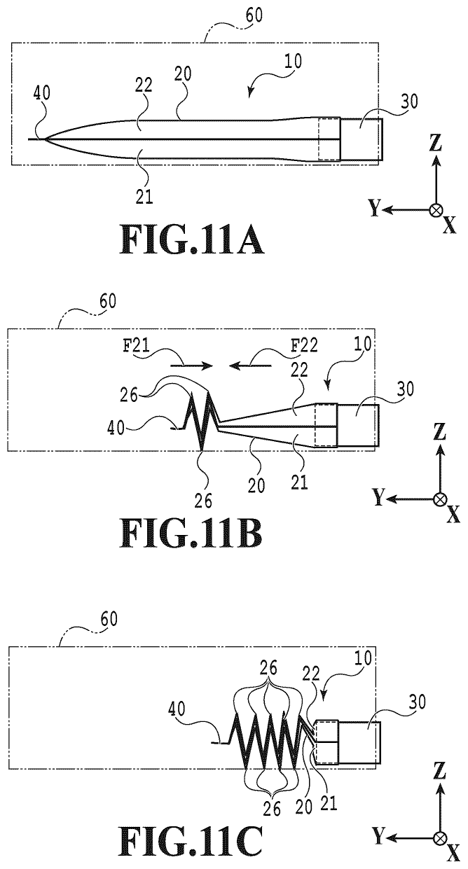

Next, a description is provided regarding the states of the liquid-containing bag 20 based on the remaining amounts of ink. FIG. 11A to FIG. 11C are side views illustrating the states of the liquid-containing bag 20 in the liquid container 10 according to the fourth embodiment. FIG. 11A is a side view illustrating the state where ink fills the liquid-containing bag 20. FIG. 11B is a side view illustrating the state where the ink inside the liquid-containing bag 20 is decreasing. FIG. 11C is a side view illustrating the state where there is only a small amount of ink inside the liquid-containing bag 20.

As illustrated in FIG. 11A, if ink fills the liquid-containing bag 20, a force that stretches the liquid-containing bag 20 into a flat plate shape is generated based on the weight and volume of the ink, and the liquid-containing bag 20 becomes stretched into a flat plate shape against the folding habit that the liquid-containing bag 20 has in each of the creases 26. As illustrated in FIG. 11B, as the ink is supplied from the liquid container 10 to the liquid ejection apparatus 100 and the amount of ink inside the liquid-containing bag 20 decreases, the liquid-containing bag 20 is gradually folded due to the folding habit that each of the creases 26 has. At this time, the folded shape of the liquid-containing bag 20 is maintained at a position where the force F21 that folds up the liquid-containing bag 20 based on the folding habit is equal to the force F22 that stretches the liquid-containing bag 20 into a flat plate shape according to the weight and volume of the remaining ink. As illustrated in FIG. 11C, if there is only a small amount of ink inside the liquid-containing bag 20, the pressure caused by the ink inside the liquid-containing bag 20 approaches zero, and thus the liquid-containing bag 20 is folded up into an accordion shape due to the folding habit that each of the creases 26 has.

Thus, inside the case 60, the liquid-containing bag 20 changes from a state extending in a flat plate shape to a state folded into an accordion shape. Therefore, as the ink contained in the liquid-containing bag 20 decreases, the length of the liquid-containing bag 20 in the extending direction (the Y direction) of the connection port 30 decreases. The used liquid container 10 illustrated in FIG. 11C is removed from the liquid supply unit 105 and removed from the case 60. Then, in place of the used liquid container 10, an unused liquid container 10 is accommodated inside the case 60 and attached to the liquid supply unit 105.

In the present embodiment, as the ink contained in the liquid-containing bag 20 decreases, the liquid-containing bag 20 is folded up, and the length of the liquid-containing bag 20 in the extending direction (the Y direction) of the connection port 30 becomes shorter. This enables preventing the space required for collecting the used liquid containers 10 from becoming large. It is possible to prevent differences in the space required for collecting the used liquid containers 10 from occurring depending on how the operator handles the liquid containers 10. Therefore, it is possible to implement the space-saving for the used liquid containers 10.

As described above, with the liquid container 10 according to the fourth embodiment, it is possible to implement the space-saving for the used liquid containers 10. That is, in the present embodiment, as the ink (liquid) contained in the liquid-containing bag 20 decreases, the liquid-containing bag 20 is folded, and the length of the liquid-containing bag 20 in the extending direction of the connection port 30 becomes shorter. This enables preventing the space required for collecting the used liquid containers 10 from becoming large. It is possible to prevent differences in the space required for collecting the used liquid containers 10 from occurring depending on how the operator handles the liquid containers 10. Thus, it is possible to implement the space-saving for the used liquid containers 10.

In the fourth embodiment, as the ink contained in the liquid-containing bag 20 decreases, the liquid-containing bag 20 is folded up due to the folding habits that the multiple creases 26 have. This enables folding up the liquid-containing bag 20 into a smaller shape with a simple configuration without using a biasing member or the like.

In the fourth embodiment, the first sheet member 21 and the second sheet member 22 are formed of the same resin material, but this is not seen to be limiting. For example, to make it easier to give a folding habit to each of the creases 26, the second sheet member 22 may be formed of a resin material different from that of the first sheet member 21.

In the fourth embodiment, the interval portions of the multiple creases 26 in the liquid-containing bag 20 (the first sheet member 21 and the second sheet member 22) may have a thickness that makes deformation hardly occur. This prevents unnecessary deformation of the interval portions of the multiple creases 26 in the liquid-containing bag 20, and the liquid-containing bag 20 can be reliably folded by the folding habits that the creases 26 have.

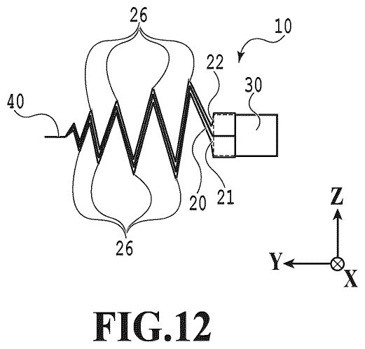

In the fourth embodiment, the lengths of the interval portions of the multiple creases 26 in the liquid-containing bag 20 are the same, but this is not seen to be limiting. FIG. 12 is a side view illustrating a first modification example of the liquid container 10 according to the fourth embodiment. As illustrated in FIG. 12, a configuration is also possible in which the length of each interval portion of the multiple creases 26 in the liquid-containing bag 20 is greater the closer it is to the connection port 30. If an interval portion of the multiple creases 26 has a short length in the liquid-containing bag 20, the volume of ink in the interval portion of the creases 26 is small. Therefore, as the ink contained in the liquid-containing bag 20 decreases, the liquid-containing bag 20 is folded toward the connection port 30 in the order from the shortest interval portion of the multiple creases 26 in the liquid-containing bag 20. In other words, in the order from the interval portion farthest from the connection port 30. This helps the ink contained in the liquid-containing bag 20 decrease.

In the fourth embodiment, the creases 26 with a folding habit of a mountain fold in the first sheet member 21 of the liquid-containing bag 20 correspond to the creases 26 with a folding habit of a valley fold in the second sheet member 22, but this is not seen to be limiting. The creases 26 with a folding habit of a valley fold in the first sheet member 21 of the liquid-containing bag 20 correspond to the creases 26 with a folding habit of a mountain fold in the second sheet member 22, but this is not seen to be limiting.

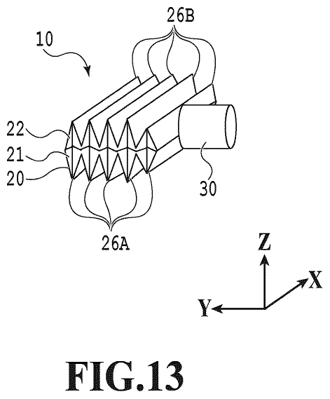

FIG. 13 is a perspective view illustrating a second modification example of the liquid container 10 according to the fourth embodiment. As illustrated in FIG. 13, the first sheet member 21 may have the first creases 26A that have the first folding habit to fold the liquid-containing bag 20. The second sheet member 22 may have the second creases 26B that are arranged to correspond to the first creases 26A and have the second folding habit oriented symmetrically to the first folding habit. The first sheet member 21 has a plurality of the first creases 26A arranged along the extending direction of the connection port 30, and the second sheet member 22 has a plurality of the second creases 26B arranged along the extending direction of the connection port 30. The first creases 26A and the second creases 26B extend in the width direction (the X direction) of the liquid-containing bag 20. For example, in a case where the first creases 26A have the first folding habit of a mountain fold, the second creases 26B, which correspond to the first creases 26A, have the second folding habit of a mountain fold symmetrical to the first folding habit. In a case where the first creases 26A have the first folding habit of a valley fold, the second creases 26B, which correspond to the first creases 26A, have the second folding habit of a valley fold symmetrical to the first folding habit. Accordingly, the liquid-containing bag 20 is folded due to the first folding habit and the second folding habit as the ink contained in the liquid-containing bag 20 decreases, so that the length of the liquid-containing bag 20 in the extending direction of the connection port 30 becomes shorter. Therefore, it is possible to implement the space-saving for the used liquid containers 10.

In the second modification example of the liquid container 10 according to the fourth embodiment, it is also possible that the first sheet member 21 has a plurality of the first creases 26A arranged along a direction intersecting the extending direction and of the connection port 30 and vertical direction (e.g., the X direction perpendicular to the extending direction and vertical direction). The second sheet member 22 may have a plurality of the second creases 26B arranged along a direction intersecting the extending direction of the connection port 30 and vertical direction. The first creases 26A and second creases 26B may extend in the extending direction of the connection port 30 (the Y direction). Accordingly, the liquid-containing bag 20 is folded due to the first folding habit and the second folding habit as the ink contained in the liquid-containing bag 20 decreases, so that the length of the liquid-containing bag 20 in a direction (the X direction) intersecting the extending direction of the connection port 30 and vertical direction becomes shorter. Therefore, it is possible to implement the space-saving for the used liquid containers 10.

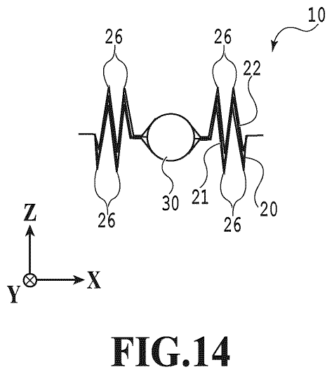

In the fourth embodiment, the liquid-containing bag 20 has the multiple creases 26 arranged along the extending direction (the Y direction) of the connection port 30, but this is not seen to be limiting. FIG. 14 is a front view illustrating a third modification example of the liquid container 10 according to the fourth embodiment. As illustrated in FIG. 14, the liquid-containing bag 20 may have a plurality of creases 26 arranged along a direction intersecting the extending direction of the connection port 30 and vertical direction (e.g., the X direction perpendicular to the extending direction and vertical direction). The plurality of creases 26 may extend in the extending direction (the Y direction) of the connection port 30. Accordingly, the liquid-containing bag 20 is folded as the ink contained in the liquid-containing bag 20 decreases, so that the length of the liquid-containing bag 20 in a direction (the X direction) intersecting the extending direction of the connection port 30 and vertical direction becomes shorter. Therefore, it is possible to implement the space-saving for the used liquid containers 10.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-068803, filed Apr. 22, 2024, which is hereby incorporated by reference wherein in its entirety.

What is claimed is:

1. A liquid container for supplying a liquid to a liquid ejection apparatus that ejects liquid, the liquid container comprising:
a liquid-containing bag configured to contain a liquid;
a connection port connected to the liquid-containing bag and configured to connect the liquid-containing bag to the liquid ejection apparatus; and
a biasing member configured to apply a biasing force to wind the liquid-containing bag,
wherein the biasing member is formed from a wire and connected to the liquid-containing bag, and
wherein the liquid-containing bag is wound based on the biasing force of the biasing member as the amount of liquid contained in the liquid-containing bag decreases so that a length of the liquid-containing bag in an extending direction of the connection port or a length of the liquid-containing bag in a direction intersecting the extending direction and a vertical direction becomes shorter.

2. A liquid container for supplying a liquid to a liquid ejection apparatus that ejects liquid, the liquid container comprising:
a liquid-containing bag configured to contain a liquid; and
a connection port connected to the liquid-containing bag and configured to connect the liquid-containing bag to the liquid ejection apparatus,
wherein the liquid-containing bag includes:
a first sheet member configured as a sheet and
a second sheet member configured as a sheet to overlap the first sheet,
wherein the liquid is contained between the first sheet member and the second sheet member,
wherein a linear expansion coefficient of a material of the first sheet member and a linear expansion coefficient of a material of the second sheet member are different from each other, and
wherein, as an amount of liquid contained in the liquid-containing bag decreases, the liquid-containing bag is wound based on a force generated based on the difference between the linear expansion coefficient of the material of the first sheet member and the linear expansion coefficient of the material of the second sheet member so that a length of the liquid-containing bag in an extending direction of the connection port or a length of the liquid-containing bag in a direction intersecting the extending direction and a vertical direction becomes shorter.

3. A liquid container for supplying a liquid to a liquid ejection apparatus that ejects liquid, the liquid container comprising:
a liquid-containing bag configured to contain a liquid; and
a connection port connected to the liquid-containing bag and configured to connect the liquid-containing bag to the liquid ejection apparatus,
wherein the liquid-containing bag includes a crease that has a folding habit to fold the liquid-containing bag, and
wherein, as the amount of liquid contained in the liquid-containing bag decreases, the liquid-containing bag is folded based on the folding habit that the crease has so that a length of the liquid-containing bag in an extending direction of the connection port or a length of the liquid-containing bag in a direction intersecting the extending direction and a vertical direction becomes shorter.

4. The liquid container according to claim 3,
wherein the liquid-containing bag has a plurality of the creases arranged along the extending direction.

5. The liquid container according to claim 4,
wherein the length of each interval portion of the plurality of the creases in the liquid-containing bag is greater the closer it is to the connection port.

6. The liquid container according to claim 3,
wherein the liquid-containing bag includes:
a first sheet member configured as a sheet and
a second sheet member configured as a sheet to overlap the first sheet,
wherein the liquid is contained between the first sheet member and the second sheet member,
wherein the first sheet member has a first crease that has a first folding habit to fold the liquid-containing bag,
wherein the second sheet member has a second crease that has a second folding habit that is positioned to face the first crease and is symmetrical to the first folding habit, and
wherein, as the amount of liquid contained in the liquid-containing bag decreases, the liquid-containing bag is folded due to the first folding habit that the first crease has and the second folding habit that the second crease has.

7. The liquid container according to claim 6,
wherein the first sheet member has a plurality of the first crease arranged along the extending direction, and
wherein the second sheet member has a plurality of the second creases arranged along the extending direction.

8. The liquid container according to claim 3,
wherein the liquid-containing bag has a plurality of the creases arranged along the direction intersecting the extending direction and the vertical direction.
